(19) United States
(12) Patent Application Publication
(10) Pub. No.: US 2009/0158095 A1
(43) Pub. Date: Jun. 18, 2009

(54) Method for testing a computer device and a computer system thereof

(75) Inventor: June-Lin Huang, Taipei City (TW)

Correspondence Address: Joe McKinney Muncy, PO Box 1364, Fairfax, VA, 22038-1364, US

(73) Assignee: INVENTEC CORPORATION

(21) Appl. No.: 12/000,859

(22) Filed: Dec. 18, 2007

(51) Int. Cl. G06F 11/00

(52) U.S. Cl. 714/37; 714/E11.001

(57) ABSTRACT

A method performed by a software module for testing a computer device. The method first selects the computer device from a device list, and links a driver of the computer device through a program interface, in which the program interface is provided by an operating system. Next, the method sets the computer device by the driver according to a function of the computer device, and records the execution time for the computer device to perform the corresponding function.

### BACKGROUND

1. Field of Invention

The present invention relates to a testing method. More particularly, the present invention relates to a testing method for testing a computer device.

2. Description of Related Art

Recently, computer technology has improved a lot, and computer devices are frequently used by people as well. For example, the display card for displaying images and messages, the audio card for displaying the voice, as well as the network adapter are commonly used in daily life. The network adapter is an intermediate for the computer to communicate with the Internet. Without the network adapter, the computer cannot link to the Internet.

After the computer device has been produced, a testing procedure is required to test the function and the performance of the computer devices. For example, the produced network adapter is tested to determine if it is able to link to the Internet, and the execution time for linking is also concerned.

However, in conventional testing procedures, the computer devices are tested by hand, which makes the testing results unreliable. Moreover, a great amount of human resource is required if a large number of computer devices need to be tested.

Therefore, there is a need for a new testing method which can save the human resources for testing and make the test results reliable.

### SUMMARY

According to one embodiment of the present invention, a method performed by a software module for testing a computer device is disclosed. The method first selects the computer device from a device list, and links a driver of the computer device through a program interface, in which the program interface is provided by an operating system. Next, the method sets the computer device by the driver according to a function of the computer device, and records the execution time for the computer device to perform the corresponding function.

According to another embodiment of the present invention, the steps for testing a computer device includes starting an testing module, getting a device list of a computer by the testing module, selecting a computer device for testing from the device list, setting the number of times for testing, linking a driver of the computer device through a program interface, in which the program interface is provided by an operating system, and setting the computer device by the driver according to a function of the computer device.

According to one embodiment of the present invention, the computer system includes an operating system, a program interface provided by the operating system, a driver module for driving a computer device, and a testing module for testing the computer device, in which the testing module communicates with the driver module through the program interface.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a flow chart of the computer device testing process according to one embodiment of the present invention;

FIG. 2 is the flow chart of the computer device testing process according to another embodiment of the present invention;

FIG. 3 shows the block diagram of a computer system according to one embodiment of the present invention; and

FIG. 4 shows the timing test results of the network adapter according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

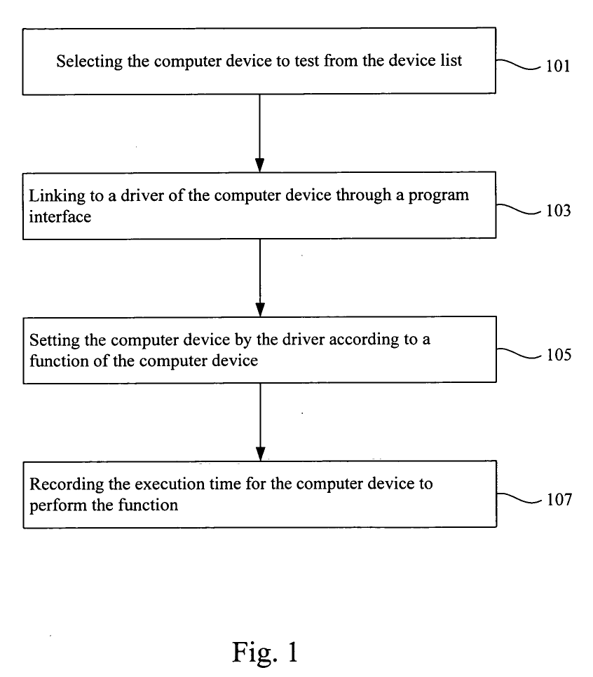

FIG. 1 is a flow chart of the computer device testing process according to one embodiment of the present invention. The computer device testing process is executed by a software module installed in a computer, such as the Visual C++ test program installed in a server. The software module first connects to the system database through the program interface provided by the operating system to get a device list, and selects the computer device to test from the device list (step 101), then links to a driver of the computer device through a program interface (step 103), in which the program interface is provided by an operating system.

For example, the software module can connect to the system database to get the device list through the Windows Driver Development Kit (WDDK) and the application programming Interface (API) which are provided by the Windows operating system. The software module can also connect to the driver of the computer device through the WDDK and the API to drive the hardware device.

Next, the computer device is set by the driver according to the function of the computer device (step 105), and the execution time for the computer device to perform the function is recorded (step 107). For example, the software module can start/suspend the network adapter for getting the execution time for starting/suspending, and the acquired execution time can be recorded into a record file for the users to review. In more detail, the network adapter may first be disabled, and re-started again after a period of time in order to get the internet protocol (IP), and the execution time for getting the IP is recorded into the record file.

The users can identify the compatibility between the network adapter and the operating system, or check the efficiency of the network adapter according to the record file. Further, the user can debug the network adapter to improve the compatibility between the network adapter and the operating system according to the record file.

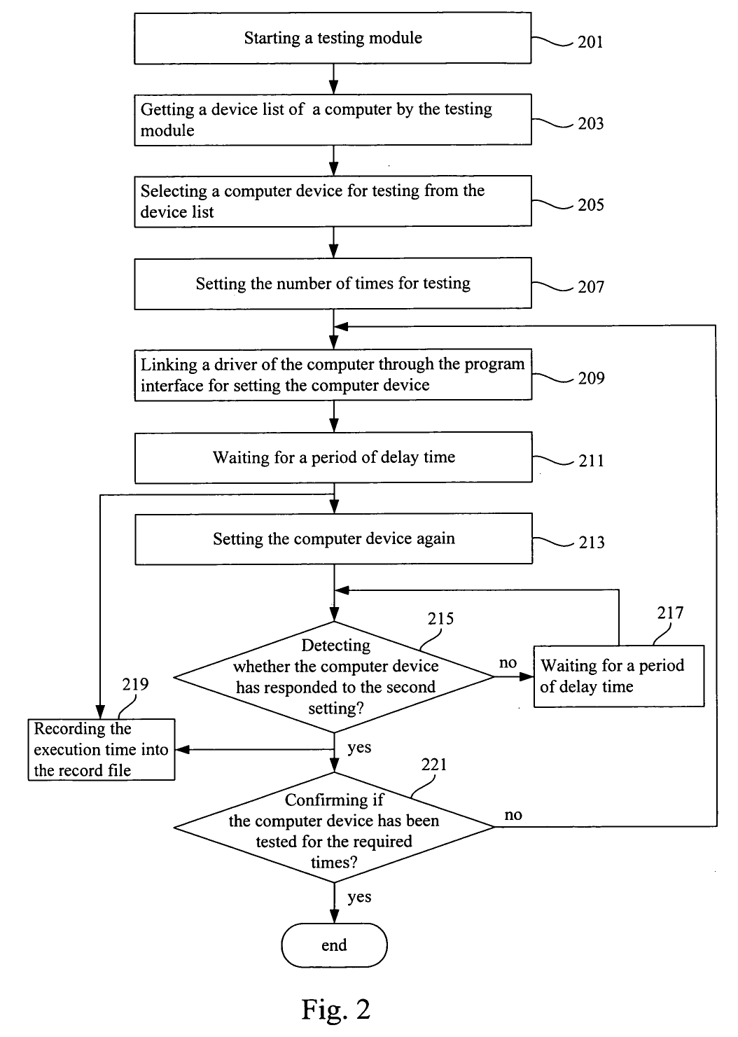

FIG. 2 is the flow chart of the computer device testing process according to another embodiment of the present invention. The process first starts a testing module (steps 201), and gets a device list of the computer by the testing module (step 203). Next, the method selects a computer device for testing from the device list (step 205). Then the user can set the number of times for testing (step 207). After that, the testing module links the driver of the computer device for setting the computer device according to a function of the computer device through a program interface (step 209), in which the program interface is provided by an operating system. For example, the testing module can connect to the driver of the network adapter through the Windows Driver Development Kit to drive the network adapter.

After the computer device has been set for the first time (step 209), the testing process waits for a period of delay time (step 211) for the computer devices to implement the settings. Then the testing process sets the computer device again (step 213) and detects whether the computer device has responded to the second setting (step 215). For example, the testing process may stop the network adapter first, wait for a period of time to set the computer device again, and detect at what time the network adapter responds to the second settings, that is, how much time is required for the network adapter to get the Internet protocol.

When the network adapter hasn't responded to the second setting, the testing process waits for a period of delay time (step 217) and detects again if the network adapter responds to the second setting (step 215). When the computer device has responded to the second setting, the execution time required for the second setting is recorded into the record file for the user to consult (step 219). For instance, the testing process detects and records the time period required by the network adapter to acquire the Internet Protocol into a record file.

After the computer has responded to the second setting, the testing process continues to confirm if the computer device has been tested for the required times set by the users (step 221). The testing process repeats the steps 209-221 if the computer device hasn't been tested for the required times. Else, the testing process is finished.

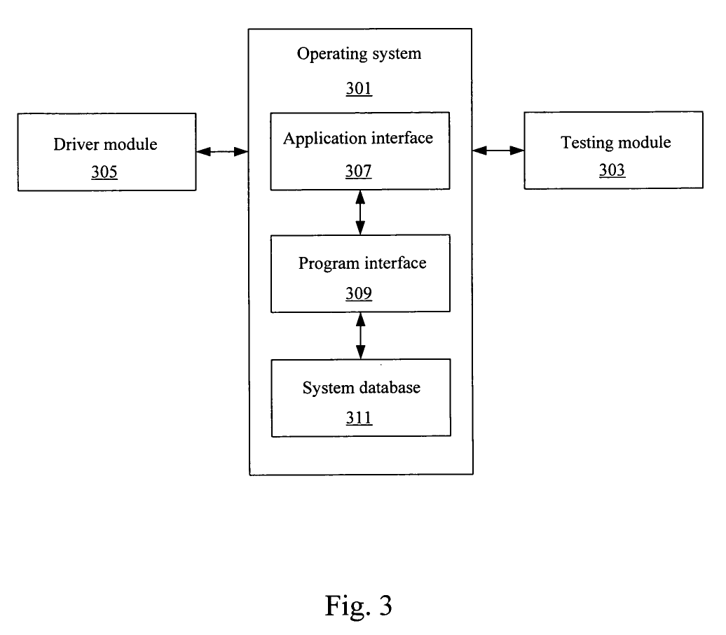

FIG. 3 shows the block diagram of a computer system according to one embodiment of the present invention. The computer system includes an operating system 301, an application interface 307, a program interface 309, a system database 311, a driver module 305 for driving a computer device and a testing module 303 for testing the computer device, in which the testing module 303 communicates with the driver module 305 through the program interface 309.

The program Interface 309 is provided by the operating system 301, such as the windows driver development kit of the Windows operating system. The system database 311 stores a device list which is used for displaying the state of the computer device, such as the enable/disable state of the network adapter. The driver module 305 drives a computer device, such as the network adapter.

The testing module 303 tests the computer devices, such as testing the required time for a network adapter to get an Internet protocol. The testing module 303 communicates with the driver module 305 and the system database 311 through the program interface 309 and the application interface 307. For example, the C++ Language test module 303 communicates with the driver module 305 and the system database 311 through the Windows driver development kit and the application program interface of the windows operating system 301.

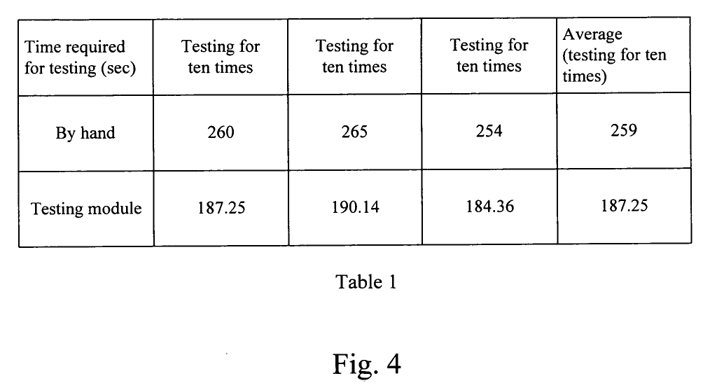

FIG. 4 shows the timing test results of the network adapter according to one embodiment of the present invention. In the table 1, we can see that the human requires 259 seconds to test the network adapter for ten times in average, while the testing module requires only 187.25 seconds. Therefore the testing module saves about 30 percent of the time for testing. Hence, the testing efficiency for testing the network adapter is improved by the testing module indeed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method performed by a software module for testing a computer device, comprising:
selecting the computer device from a device list;
linking a driver of the computer device through a program interface, wherein the program interface is provided by an operating system;
setting the computer device by the driver according to a function of the computer device; and
recording the execution time for the computer device to perform the function.

2. The method for testing the computer device as claimed in claim 1, further comprising outputting the execution time to a record file for a user to consult with.

3. The method for testing the computer device as claimed in claim 1, wherein the computer device is a network adapter.

4. The method for testing the computer device as claimed in claim 3, wherein the network adapter is first disabled, and re-started after a period of time in order to count the execution time for the network adapter to re-start.

5. The method for testing the computer device as claimed in claim 4, wherein the execution time is the time required for the network adapter to get an internet protocol.

6. The method for testing the computer device as claimed in claim 1, wherein the device list is stored in a system database and acquired through the program interface.

7. A method for testing a computer device, comprising:
starting an testing module;
getting a device list of a computer by the testing module;
selecting a computer device for testing from the device list;
setting the number of times for testing;
linking a driver of the computer device through a program interface, wherein the program interface is provided by an operating system; and
setting the computer device by the driver according to a function of the computer device.

8. The method for testing the computer device as claimed in claim 7, further comprising counting a response time of the computer device after the computer device has been set.

9. The method for testing the computer device as claimed in claim 8, further comprising outputting the response time into a record file for a user to consult with.

10. The method for testing the computer device as claimed in claim 8, wherein the response time is the execution time required for starting/stopping a network adapter.

11. The method for testing the computer device as claimed in claim 10, wherein the network adapter is first stopped, and re-started after a period of time.

12. The method for testing the computer device as claimed in claim 10, wherein the execution time is the time required for the network adapter to get an internet protocol.

13. A computer system, comprising:
an operating system;
a program interface provided by the operating system;
a driver module for driving a computer device; and
a testing module for testing the computer device, wherein the testing module communicates with the driver module through the program interface.

14. The computer system as claimed in claim 13, wherein the testing module counts an execution time required for a network adapter to get an internet protocol.

15. The computer system as claimed in claim 13, wherein the testing module is a C language testing module, and the C language testing module communicates with the program interface through the operating system.

16. The computer system as claimed in claim 13, wherein the program interface is a driver development kit.

17. The computer system as claimed in claim 13, further comprising a system database for storing a device list which is used for displaying the state of the computer device.
